(19) United States
(12) Patent Application Publication
(10) Pub. No.: US 2019/0228429 A1
(43) Pub. Date: Jul. 25, 2019

(54) SAFETY INDEX FOR THE CALCULATION OF A RATING BASED ON USER GENERATED REPORTS OR ACTIONS AND REWARDS SYSTEM THEREFOR

(71) Applicant: Vizsafe, Inc., Middletown, RI (US)

(72) Inventors: Peter Allen Mottur, Portsmouth, RI (US); James Edward Cobery, Bristol, RI (US); Claude Pierre Sheer, Asheville, NC (US); Nathan R. Whittaker, Newport, RI (US)

(73) Assignee: Vizsafe, Inc., Middletown, RI (US)

(21) Appl. No.: 16/256,795

(22) Filed: Jan. 24, 2019

Related U.S. Application Data
(60) Provisional application No. 62/621,654, filed on Jan. 25, 2018.

(51) Int. Cl. G06Q 30/02; G06Q 30/06; G06Q 20/40; H04L 9/32; H04L 9/06

(52) U.S. Cl. CPC G06Q 30/0218; G06Q 30/0225; G06Q 30/0609; H04L 2209/56; H04L 9/3236; H04L 9/0637; H04L 2209/38; G06Q 20/401

(57) ABSTRACT

The method and system allows for users to share and be rewarded for information submitted or actions performed, including reports containing messages, images, videos, and geolocation data, of any issues they encounter. The submissions can be shared with the appropriate organization and/or stored on a server, and uploaded to a blockchain to ensure that there is a permanent, tamper-proof record verifying the authenticity of all related transactions. Each submission or action can be verified to create a rating for each user. The system can additionally provide a trust rating for a municipality, facility, venue or organization itself as well. Such a trust rating can be a function of the number of reports submitted by users and the resolution of such reports. The system can have the ability to reward users with digital value in return for receiving and verifying authenticity of the information, and to provide such users with the ability to redeem those rewards for goods and services.

### CROSS REFERENCE TO RELATED APPLICATION

This patent document claims priority to earlier filed U.S. Provisional Patent Application No. 62/621,654, filed on Jan. 25, 2018, the entire contents of which are incorporated herein by reference.

### BACKGROUND OF THE INVENTION

Maintaining security at major sporting and events venues has never been more complex. The crowds of people who attend these events represent a tremendously powerful resource, which current systems fail to take full advantage of—if at all. The crowds of people at given event or location represent thousands or tens of thousands of people who are on the ground at an event, often with a vantage point that many security systems and companies could never attain on their own.

Wherever crowds of thousands or tens of thousands of people gather for major events, hosts and organizers are faced with the daunting task of maintaining not only their safety, but the quality of their experience. Many visitors will have spent significant time and money to attend, and ensuring a great guest experience at the event is paramount to the value of organizers' brands.

While this manifests itself in dozens of minor details, from the availability of parking spaces to the time spent queuing for hot dogs, there are also acute security concerns wherever so many people gather together. Once again, minor details can be of critical importance: an unattended bag, an aggressive visitor, ‘trip and fall’ hazard, or suspicious damage to the facility.

While venues often have dedicated employees and security teams to deal with such issues, those who are very best placed to notice anything amiss include the thousands of visitors themselves. The crowd is a fantastic, but untapped, resource. Yet, the reality is that in many cases, visitors will overlook a problem for want of a simple but universal process to report it to the appropriate body. Sometimes, the lack of immediate incentive to take the time and effort to do report an issue will prevent someone from taking their time to alert someone. Simply put, a minor issue is likely to be seen as ‘someone else's problem.’

As such, there remains a need for systems and methods for creating a system for reporting accurate and relevance information, incentivizing crowds to provide such relevant and accurate information, and systems and methods for transmitting and verifying this data.

### SUMMARY OF THE INVENTION

The instant invention provides a solution to the aforementioned problems of the prior art by allowing any user to upload safety reports through a common platform, or application. A user can submit images and videos of any issues they encounter or perform actions requested by an organization, which are automatically timestamped and geo-tagged. The submissions can be shared with the appropriate authority and/or stored on a third party server. Moreover, hashes of this information are uploaded to a blockchain to ensure that there is a permanent, tamper-proof record of all transactions recorded. The submission can then be verified for each submission to create a rating for each user. If the information provided by the user is accurate, then the user's rating can be increased. If the information provided by the user is inaccurate, the user's rating can be decreased. Such a rating can provide a weight to the value of information provided by a given user. The system can additionally provide a trust rating to the organization (i.e., a municipality, facility or venue) itself as well. Such a trust rating can be a function of the number of reports made by users and the verification and resolution of such reports. An organization can use this valuable information to create new protocols to increase their trust rating, whether by reducing the overall number of incidents to report and/or reducing the time to resolve any reported incidents.

The instant application provides a system for users to voluntarily report and share information when they are proximate to the organization requesting such information from a user based on the user's geolocation or other location preferences. The system allows users to: (a) send their own targeted messages (text or multimedia) to users in a proscribed geofence, (b) request assistance or make other requests for information from individuals or organizations, (c) volunteer (opt-in) to share information with requesting organization (such as location, real-time tracking of their location data, user preferences and customer service feedback), and (d) volunteer (opt-in) to perform tasks or other actions with requesting organization (such as responding to a call to action, parking in a specific location, visiting a specified retailer or vendor, etc.).

Requesters have the ability to reward users with digital value in return for receiving information and verifying authenticity of said information. This reward may be in the form of tokens, coins, cryptocurrencies or other items of digital value stored in a user's digital wallet which is solely dedicated to each individual or requesting organization.

The present invention is directed to a method and system that provides users with the ability to redeem those rewards, issued by requesters, for goods and services from vendors proximate to the user's location. For example, the method and system facilitates this transaction of value transfer between parties in three possible ways: 1) means enacted by a single user within the application, 2) means through recognition and acceptance of a physical code, or 3) means through recognition and acceptance of electronic code. Such a code may reference a public wallet address (i.e., a hashed public key or cryptographic code recorded on a blockchain network) that allows digital value to be transferred from one wallet address to another wallet address. The codes can be manually entered or scanned using a camera with a reader (such as a bar code or QR code reader), automatically added using near-field communications (NFC) or other forms of wireless data transfer.

In view of the foregoing, there is demand for a method and system that gives users the ability to crowdsource incident reporting at large scale, or small scale, events, rate users and venues, provide rewards to users for information, and redeem rewards with participating organizations, partners, vendors or other entities that consent to accept the reward as a unit of measurable value in exchange for their respective goods or services.

Any of the above discussed portions of the system can be used individually or in any combination. They need not be used together or at the same time.

### BRIEF DESCRIPTION OF THE DRAWING FIGURES

The novel features which are characteristic of the method and system described herein are set forth in the appended claims. However, the example implementations and embodiments, together with further objects and attendant advantages, will be best understood by reference to the following detailed description taken in connection with the accompanying drawings in which:

FIG. 1 is a schematic view of a portion of the system described herein;

FIG. 2 is a flow chart of the method of the system described herein;

FIG. 3 is a block diagram of the system architecture;

FIG. 4 is a block diagram showing information sharing between various nodes in the system;

FIG. 5 is a block diagram of the ecosystem of the system described herein;

FIG. 6 is a flow chart showing a method for carrying out the present invention within the system without the need for code recognition;

FIG. 7 is a flow chart showing a method for carrying out the present invention using recognition and acceptance of a physical code;

FIG. 8 is a flow chart showing a method for carrying out the present invention using recognition and acceptance of an electronic code; and

FIG. 9 is a flow chart showing a method for carrying out the present invention using an alternative method.

### DESCRIPTION OF THE INVENTION

The following detailed description of example implementations refers to the accompanying drawings. The same reference numbers in different drawings may identify the same or similar elements.

The present invention generally provides for a system and method that employs a number of networked hardware devices, such as computers, cameras, mobile devices, and the like, that are interconnected to a network, such as a private network or the Internet. As is well known in the art, such computers and other devices include their respective microprocessors, RAM, storage (such as in the form of solid state, hard disk or otherwise), communication interfaces and power supplies. These devices are so well known that they need not be discussed in further detail herein. Moreover, use of such devices is required to carry out the present invention as the invention cannot be carried out without the use of such systems and devices.

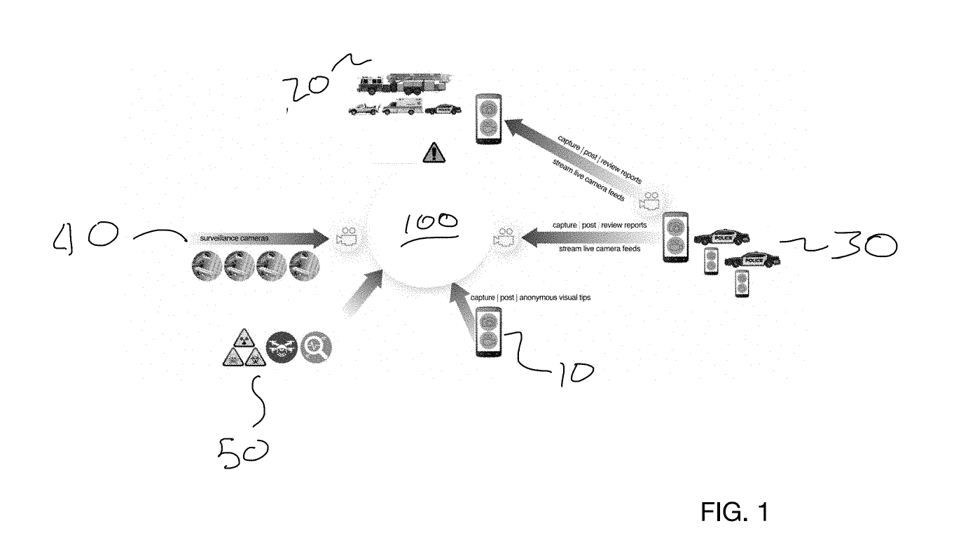

The ability of now-pervasive smartphones to take pictures and videos, coupled with broad acceptance of social sharing, have transformed the collection, distribution and use of rich media for a host of purposes. In order to utilize these capabilities to improve facility and public safety at various venues, a system for receiving and responding to valued action reports or actions is provided for herein, as shown in FIG. 1. Connecting ordinary citizens, or the public, 10 with organizations responsible for safety and security, including first responder partners 20 and the organization, facility or venue command and control 30, with camera networks 40 and sensor networks 50 has the potential to be a force multiplier of unparalleled proportions. The instant system 100 can compile information from the public in the crowd 10, personnel working at the event/venue 30, law enforcement 20, and the camera and sensor networks 40, 50. The organization, facility or venue owner, manager or event organizer, 30 can be any number of stakeholders including local law enforcement, municipalities, corporations, businesses, venue management, or other entities. Each of the various users 10 and stakeholders 20, 30 can be connected together via a common network 100. A mobile application 200 can be used to create each node within the network 100. The network 100 can include additional sensors including cameras 40, drones, and other environmental sensors 50 to provide additional data. Communication between each node can be secured or unsecured, wired or wireless, or any type of communication. In some cases, the addition of blockchain 300 can provide an immutable record of such information reporting and actions that can only increase the efficacy of the system and the ability of the users 10 to verify any trust ratings of the organization 20 or the reporter. Moreover, the system can provide digital rewards and other incentives for users to report or share information when they witness it or upon request, so that they don't just presume that it is someone else's problem.

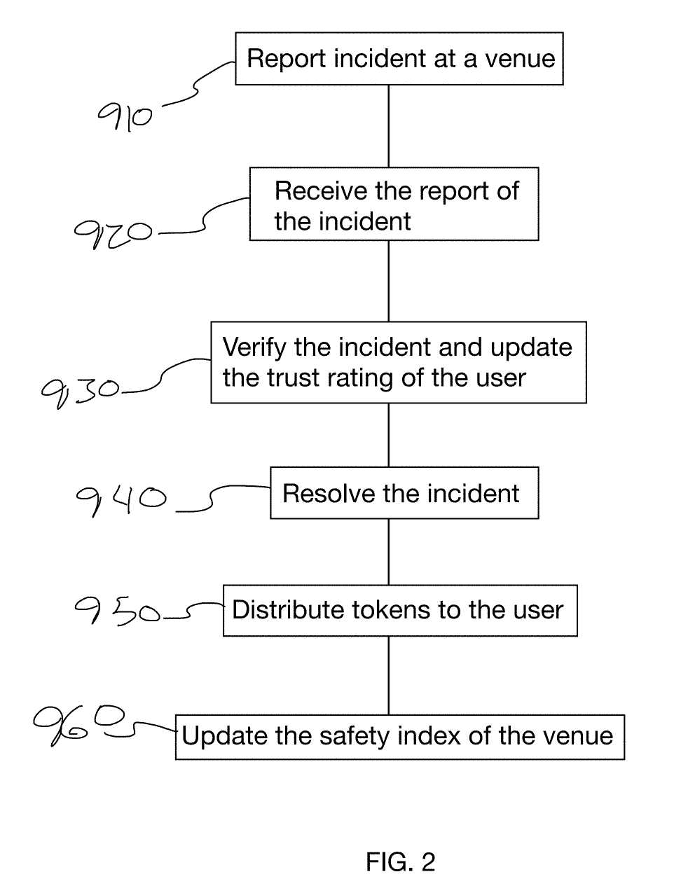

In general, as shown in the flow chart of FIG. 2, the method can include the following steps. The method of FIG. 2 is a simplified flow chart which does not account for all aspects of the methods and systems disclosed herein. Moreover, the steps need not be completed in the shown order or in the shown combination. For example, a user 10 can witness an incident at an event and use the mobile application 200 to report the incident to the event organizers 20 (Step 910). The report can be received by the venue or event organizers 20 (Step 920) and the report can be verified by employees or contractors of the venue (Step 930). The verification step can additionally include updating the user's 10 trust rating as a function of how accurate the report was. The venue or event organizer can resolve the reported incident (Step 940). In exchange for accurate report information provided by the user 10 to the venue 20, the venue 20 can distribute reward tokens to the user, discussed further below (Step 950). The safety index, discussed further below, of the venue can be updated as a function of how quickly and completely the venue resolves the incident (Step 960).

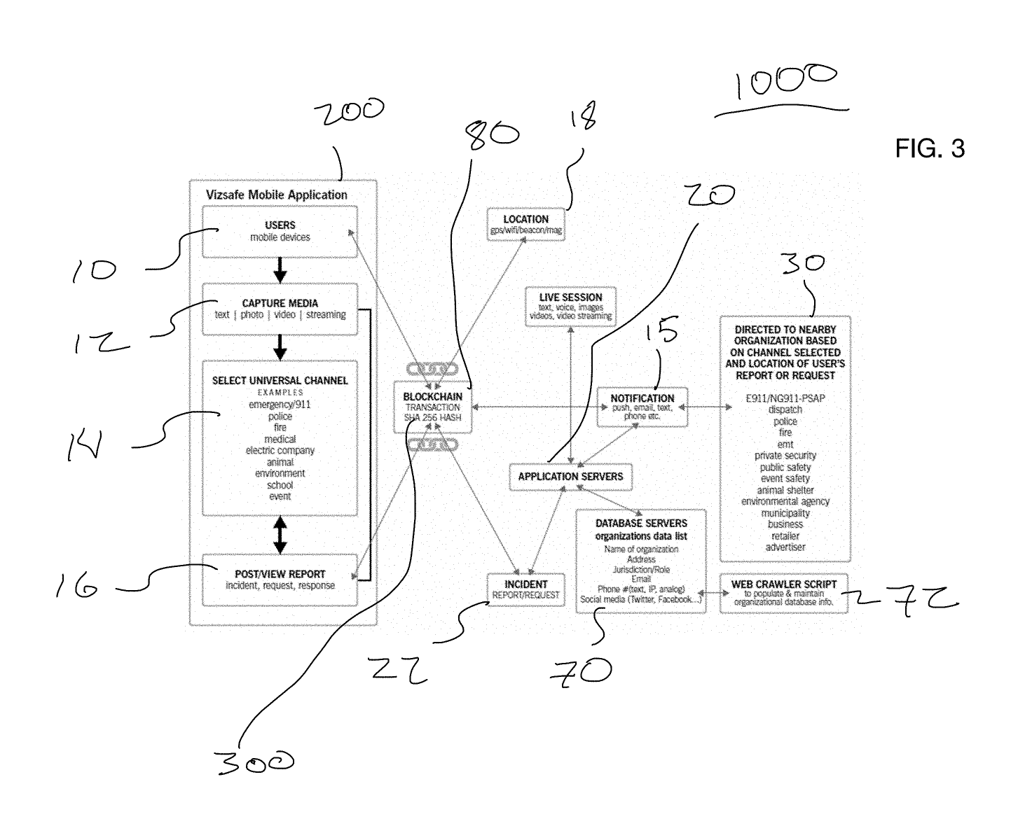

The present invention leverages a platform 1000, as shown in FIG. 3, for providing real-time mobile incident reporting 16, mapping 18 and visual 12 communications for facility management, security, and safety applications. To serve such users 10, the instant platform improves situational awareness, response and resolution of issues that are reported by personnel, partners and visitors; this can include notifications 15 via push, email, text, or phone calls to the user. The user may designate specific channels 14 to report to or receive notifications from, such as fire, medical, environmental, venue, etc. This system 1000 can seamlessly map, timestamp, categorize, and filter visual reports captured from smartphones 10, enabling the venue 20 to submit actionable reports 22 regarding safety risks, hazards, threats, and maintenance issues. The instant invention can thus improve response time and interagency effectiveness in the event of an incident. In addition, the venue 20 is able to share operating and maintenance reports with third party providers of facility services 30, including public and private security, government agencies, or other partners. Further, through their active participation, these ordinary users 10 are reducing risk and improving security at some of the world's most complex and valuable venues.

The instant ecosystem consists of a number of layers, detailed in FIG. 3. The end user 10 can engage directly with the mobile app 200, which can be installed on their respective mobile devices. The mobile application 200 can allow each individual to capture data 12, tag it with relevant information 14 and submit it to the network 16. Further data such as geo-tagging 18 will be provided automatically by the mobile device, communication with local nodes, or via the mobile device IP address. The mobile app 200 also allows customers, such as event hosts, to interact with safety reports 22 via notifications 15.

The mobile app 200 can allow users to create an account with a profile of their preferences and interests. Such a profile can be anonymous, such that the personal information of the user 10 is not known to the system. Users can then anonymously send, receive and share important safety information (i.e., incident reports with geo-located photos and videos) that impacts their well-being or the venue's well-being. Once verified by the venue 20, the reports 22 can be shared with other participating users and venues based on proximity. Such a capability has the potential to:

a. Ensure trusted communication between users 10 and venues 20, verified by the venue organizer responsible for public safety. Trusted communications empower everyone to be good citizens while protecting the welfare of themselves, loved ones and friends.

b. Provide reward tokens 60 to users 10 who submit valuable and actionable incident reports 22 that have been verified by the venue 20 with safety, security or maintenance responsibility in the ecosystem.

c. Strengthen a user's 10 ‘Trust Rating’ as they earn more reward tokens 60 from their verified reports 22, which facilitates priority response and resolution to critical issues.

d. Generate a safety index rating for each venue 20 based on reports and resolution times.

The instant software as a service (SaaS) platform 1000 can provide a comprehensive suite of solutions for small to large organizations (i.e., municipalities, facilities and venues) 20 and related partners 30 with real-time incident reporting, mapping and visual communications for facility management, security and safety applications. The platform 1000 can improve situational awareness, response time and resolution of issues that are reported by their users, including personnel, partners and visitors of their facilities. These organizations 20 can purchase and utilize cryptocurrencies or tokens 60 to reward valued action participation once a report has been verified. Blockchain 300 not only provides a secure data environment in which to collect and act on valued action participation; the platform 1000 also provides the accountability required to deliver improved trust and/or tangible rewards 60, while simultaneously reducing an organization's risk profile and strengthening their safety index rating.

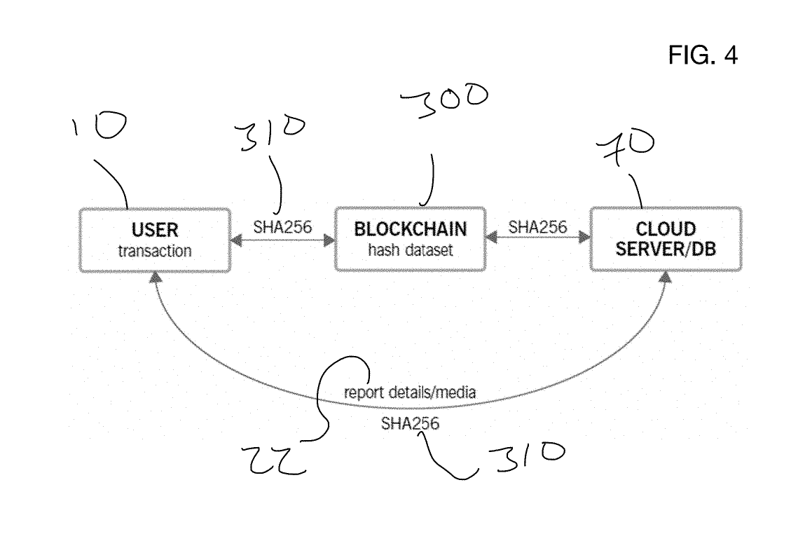

The submitted reports, actions and related data can be recorded on a blockchain based network of distributed nodes 300. The blockchain can serve as a verification layer for data uploaded: an immutable and timestamped record of every user generated report or action performed, the status of such actions, and all related transactional history, as shown in FIG. 4. Hashes of all data are stored on the blockchain, allowing authentication of every image, video, message and metadata stored on the servers. The continuously-updating and tamper-proof record can then be used to organize an evolving response strategy. The system 1000 is thus an immutable record which can be trusted to ensure that the organizations, customers, or the crowd, are correctly and accurately compensated for sharing information, data and reports. Furthermore, through the execution of smart contracts in the blockchain ecosystem, rewards can be cost effectively and securely distributed to, transferred and redeemed by the users of such ecosystem.

The present system 1000 leverages blockchain 300 to create a decentralized ledger of safety reports 22. The decentralized ledger 300 enables anyone, anywhere to serve as a node on the network and earn reward tokens 60 in exchange for verified safety reports 22. Similar to customer loyalty programs provided by hotels, airlines and retailers, the instant system 1000 reinforces users' self-interest with valuable rewards to create a powerful incentive for users to be aware of their surroundings, submit as many reports as they can and sell the reports to venues. Venues 20, in turn, will be incentivized to enlist user 10 participation across the ecosystem as a force multiplier to reduce both liability and manpower, while ensuring a safe and secure environment for everyone to enjoy. While reference is made to tokens 60, it is understood that any number of, or fractions of, tokens can be exchanged.

A blockchain 300, like the one used in the instant system, is a distributed peer-to-peer (P2P) database that is used to maintain a list of records. The blockchain 300 can allow digital information to be distributed amongst nodes in a network, without the ability to alter information. Blocks of information are stored across the blockchain so that the information is not controlled by a single entity and the database has no single point of failure. This also means that the recorded information cannot be corrupted and is fully transparent.

The fundamental premise of the instant blockchain security model is to enable a distributed ledger that lives on all the nodes in the system with information provided by users' smart devices, venue devices, local and remote servers, etc. Such an arrangement augments the security schema and eliminates the need for a centralized authoritative transaction repository, while increasing the difficulty of tampering. As more data is compiled in the instant system, the size of the blockchain grows. This hash dataset includes the details for every transaction executed on the platform. A hash 310 can include cryptographic functions (i.e., SHA256) which are one-way mathematical operations that provide a unique “fingerprint” for a file or data. If the hash 31 of a key data is securely recorded (i.e., on the blockchain) at the time of upload, the integrity of the file can be verified at any time by comparing the hash 31 with the initial record. Such a trust in a security system is a large benefit to security models.

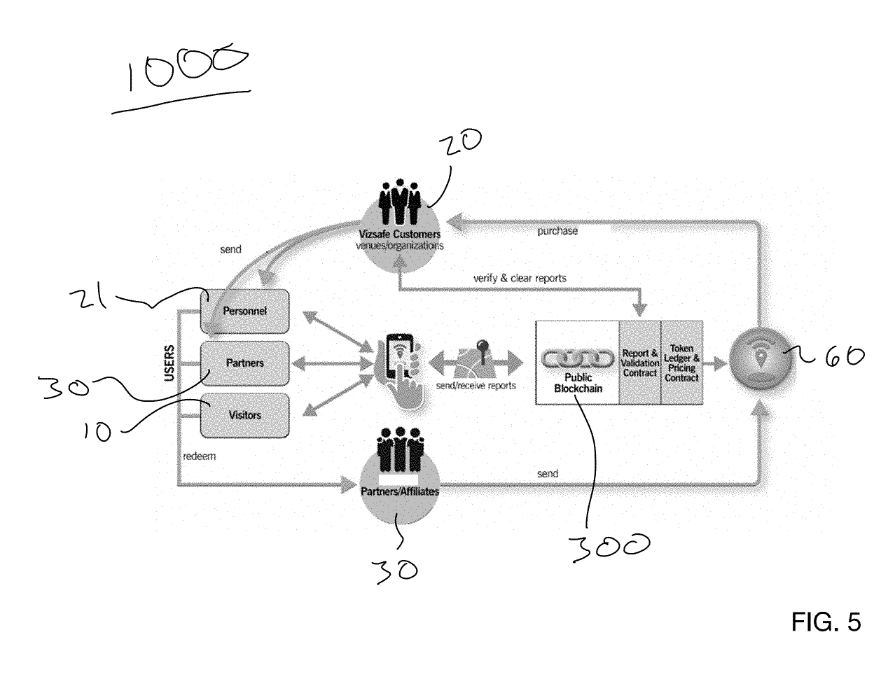

With the introduction of blockchain 300 and reward tokens 60 into the system, the system has the opportunity to create alignment between users 10 and venues 60 for the purpose of improving safety and security, as shown in FIG. 5. The system anticipates that venues 20 will reward users 10 with cryptocurrency, or tokens, 60 in return for users submitting verified safety reports or performing a call to action requested by the proximate organization, municipality, facility or venue. As a result, the system expects that growth in report volume will serve as a ‘force multiplier’ improving safety and reducing costs, which in turn will increase demand for such reward tokens or cryptocurrency in the ecosystem.

Depending on each specific venue, users will be able to redeem cryptocurrency, or tokens, 60 to purchase products and services from the venue, such as seat upgrades, VIP passes, and merchandise or concessions from vendors, as shown in FIG. 5. One example of such a token are ERC20-compliant tokens, which can ensure interoperability between smart contracts and decentralized applications. Vendors 21 can use tokens 60 as a form of payment to the venue 20 (for example as partial payment for the space a vendor occupies). In turn, the venue 20 could use these tokens 60 to reward the next valued action or to purchase additional services from the servicer.

The present invention involves at least three methods of initiating the transfer of value of a reward token from one individual or organization to another. In each of the methods disclosed herein, the value of the tokens in US dollars (or other local currencies, or fiat money) can be referenced so that the correct amount of tokens can be transferred based on the value of goods or services being provided.

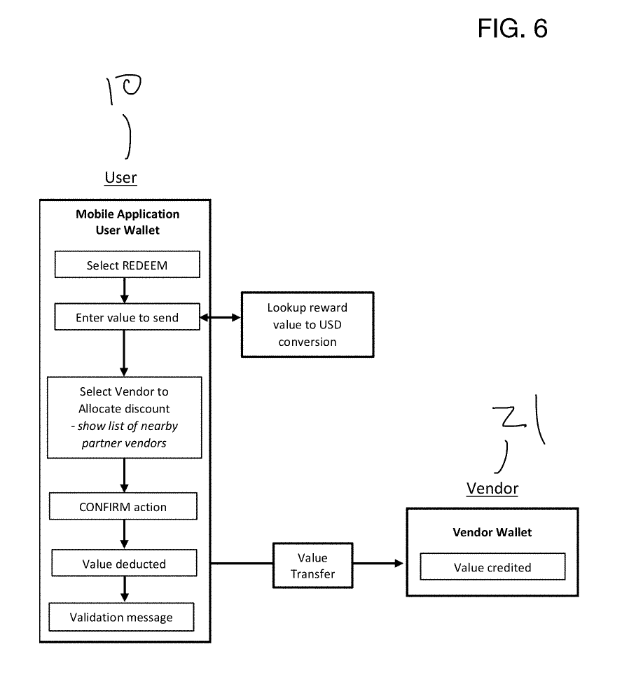

FIG. 6 describes a first method for transfer of value of a token. For example, a user 10 who has received an amount of tokens 60 may desire to use the tokens 60 to receive goods or services at a venue 20. The user 10 can thus select a vendor 21 from a list of vendors, within the mobile application 200, in proximity to the user's location. The user can then initiate and confirm the transaction upon receipt of the goods or services. Upon the confirmation action by the user 10, the user's wallet can have the tokens deducted and transferred to the vendor's wallet 202. Once the transaction is complete, a validation message can be sent to the user's mobile application 200.

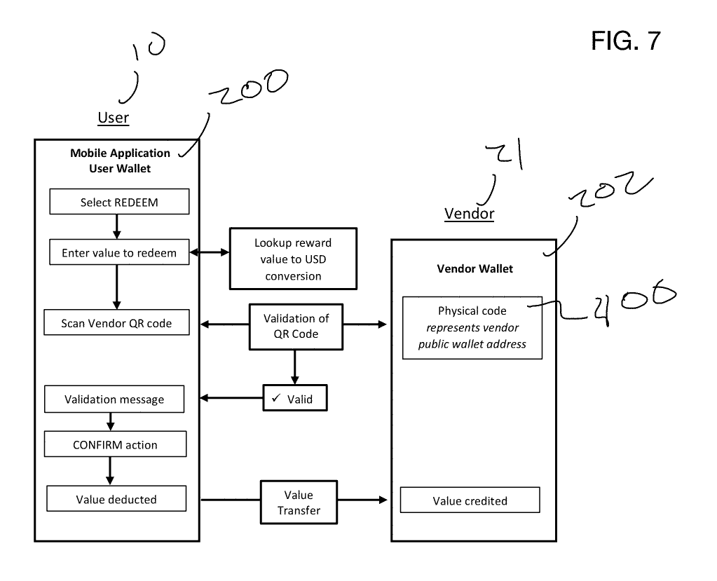

In another example, FIG. 7 describes one method by which the user 10 scans a physical code 400 with their mobile device. The user 10 can use the mobile application 200 to redeem tokens 60 by selecting a redeem function and determining the amount of value to be redeemed. The physical code 400 can be provided by the vendor 21 representing the vendor's public wallet address. The system 1000 can validate the code 400 before, or after, the user confirms the transaction. The tokens 60 are only transferred once the user 10 confirms the transaction via the mobile application 200. Once the user 10 confirms the transaction, the value of tokens can be transferred from the user 10 to the vendor 21.

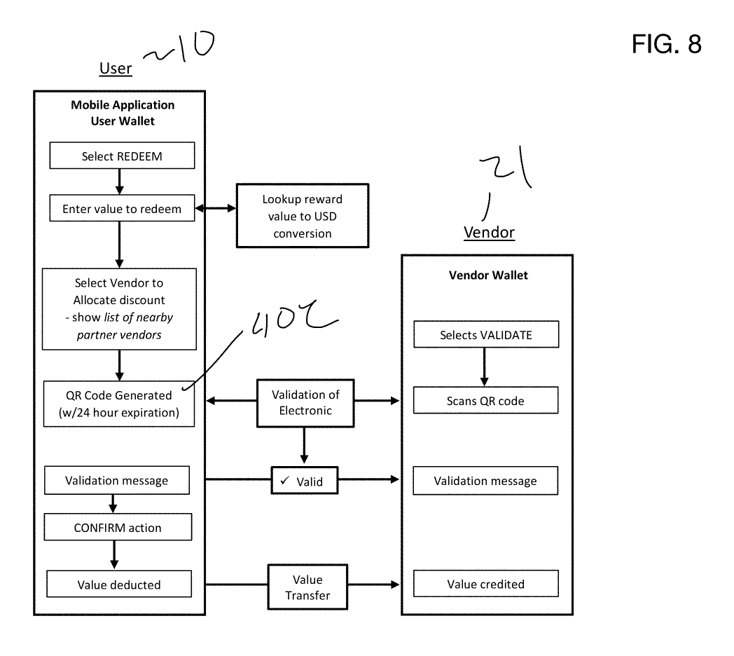

In yet another example, FIG. 8 describes another method by which the user 10, using a mobile device, generates a code 402 representing a specified value and the vendor scans, with a second mobile device, the code which initiates the transaction that is then confirmed by the user.

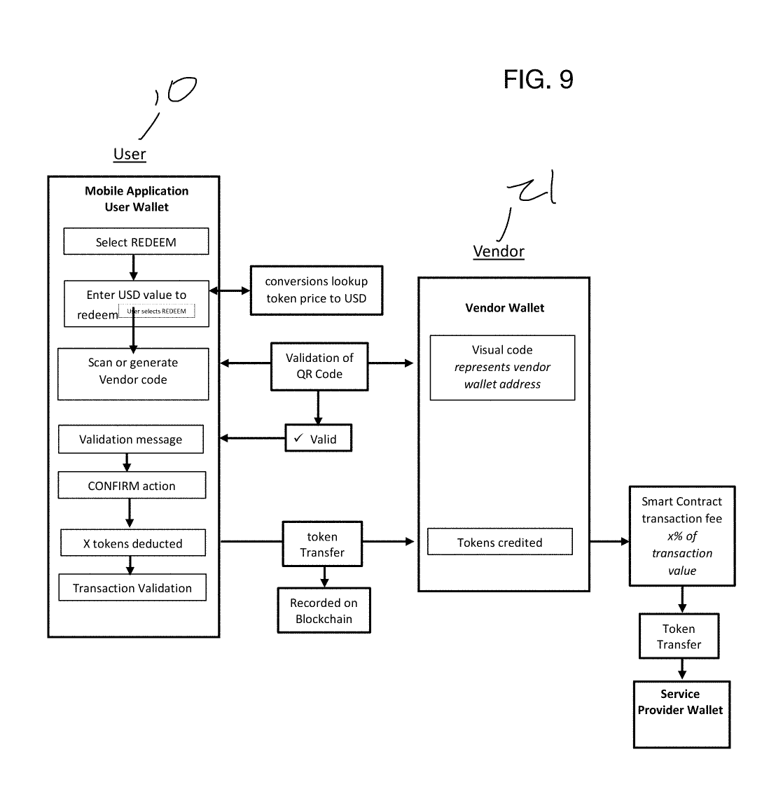

In an additional example, FIG. 9 describes one method by which the user 10 scans or generates a physical code either provided by or representing the vendor's 21 public wallet address, and the user 10 confirms the amount of transaction to be sent in tokens or other digital currency. In any of the aforementioned examples, a transaction fee can be deducted from the amount sent to the vendor and forwarded to the service provider's public wallet address.

For all of the transfer methods, the transfer of digital value moves from the user wallet to the vendor wallet within the embodied application. Optionally, a transaction fee can be automatically deducted from the proceeds sent to the vendor wallet and forwarded to the application services designated wallet as detailed in FIG. 9 (i.e., the administrator of the application services or parent organization). Such a transaction can occur over any global network of computers with a recorded ledger (either a centralized or a decentralized/distributed ledger such as one recorded on the blockchain network discussed above).

For example, a user at a facility provides information to the facility requester organization which is verified for authenticity. The facility organization then manually or automatically issues the user a reward of value in the form of a token. The user can then use one of the three aforementioned methods to redeem the accumulated rewards at participating vendors in exchange for goods or services. A transaction fee (as a % of the value being transferred) for providing such services is automatically sent to the service provider.

The instant invention additionally benefits the venues and can offer real-time situational awareness of any matters of relevance to venue operators or event hosts, from minor issues such as a faulty seats, empty vending machines or broken glass on the ground, to eyewitness data about major security incidents. Individuals on the ground, including employees, contractors and visitors, can use their smartphones to take pictures and upload geo-tagged and time-stamped information. Uploading accurate incident reports rewards users in tokens. Use of tokens is driven by an expanding customer base of event hosts who benefit by gaining access to this actionable data, enabling them to resolve problems and improve their facility's trust rating.

Another use example of the instant invention can include traffic management. For example, road users are best placed to provide up-to-date information about the state of the routes on which they are traveling. Reports can include reports of congestion and accidents, as well as potholes, debris on the road and other risks, or can be gathered passively through a user's location tracking data. These reports and related location or tracking data can be used to help plan a safety response by the relevant authorities, as well as by third-party applications such as subscription services to motorists.

Another use of the instant invention can be facility maintenance. Facility managers, such as hotel owners and serviced office space hosts can effectively outsource reporting of maintenance issues to a much larger workforce in the interests of speeding resolution. For example, any employee can report a broken ceiling light, a plumbing leak or minor damage to the maintenance department and be rewarded with a token for their report. A similar approach may be used for citywide municipal applications, such as faulty street lights, parking meters and so on.

Yet another use case can be for response to terrorist incidents. The acts of terrorism committed in large-scale sports facilities and arena venues are by now all too familiar. The challenge venue operators face is simultaneously the need to protect both the visitors and the facility. Creating a sense of security that does not sow seeds of doubt regarding facility safety is essential. There are many advantages to leveraging the existing infrastructure, enriching and distributing a common operating picture, and enlisting the support of everyone involved (including visitors or fans) as a force multiplier. The opportunity is to scale distribution of these capabilities to assist appropriate first responders—police, fire, medical—to respond to threats based on their proximity and/or jurisdictional responsibility.

In addition to providing a quid-pro-quo for reporting information by users and awarding them with tokens, the system can provide for a safety index for a given organization. The safety index has been developed as an algorithm that calculates a rating based on user-generated reports in popular locations, such as sports and entertainment venues, shopping malls, hotels and resorts, colleges and universities, and even municipalities. The algorithm calculates a safety index and displays a percentage value (0-100%) with 100% being the highest rating. The formula to calculate the safety index is a function of the total number of reports cleared (verified and/or resolved), divided by the total number of reports submitted. Such a safety index can be viewable by anyone and is dynamically driven by the crowd depending on the number of reports sent and speed of resolution. Customers will have the ability to receive these crowdsourced reports in real-time, so that they can respond and resolve them in a timely manner. Non-customers will be able to subscribe in an effort to improve their safety index and reputation.

The safety index can provide a dynamically-driven trust rating for venues, calculated in real-time from user-generated reports. A venues' safety index rating can be public and can be viewed by anyone—fostering a healthy interest in achieving the highest possible score. Just as the individuals who use the instant system would receive a Trust Rating that reflects how reliable their safety reports are and that impacts the amount of token rewards they are granted, so too venues are given a rating to show how responsive they are to addressing the issues that users report.

The instant safety index is calculated using an algorithm that calculates a multidimensional score, based on user-generated reports and event hosts' resolution of them in popular locations such as sports and entertainment venues, shopping malls, hotels and resorts, colleges and universities, and even municipalities. Data can be sourced directly from the information stored on the blockchain.

One example of the safety index in use is at a large convention center based in a City. Over recent months, as they compete for market share, the Expo learns that their safety index rating is not as favorable as that of other conference venues in the area. The Expo owners decides to invest in implementing instant platform ahead of a forthcoming event. The implementation of the instant system can streamline their processes and facilitate swift resolution of any problems, and allows the Expo to begin establishing a transparent and public trust rating.

Before the event, the Expo links a series of API feeds to its account. These can include public data from the Department of Transportation (in City), which provides information about accidents, closures and roadworks, local weather conditions, private feeds from traffic and municipal pothole reporting apps and external review sites that cover restaurants, cafes and facilities within the center. This information can help to ensure visitors arrive safely, enjoy a great guest experience and gives the public a more complete picture than would be provided solely through issues reported within the venue during the event.

Throughout the conference, visitors are encouraged to upload reports for any matters of concern they experience. They are rewarded with tokens whenever the event organizers resolve a verified issue. The same entries in the blockchain that are used to mark reports as resolved and reward reporters with tokens can also used to provide a safety index rating for the venue. Factors used to calculate the safety index can include the severity of each issue reported, the nature of the problem, and how fast it is resolved. Information from the external linked APIs further nuances this rating. While factors outside of the venue's control such as traffic accidents do not impact the core rating figures, they help provide broader context and a more rounded score in this multidimensional rating system. As a result of the collection of data and resolution of reported incidents, the Expo can not only improve safety, speeds resolution of outstanding issues, and reduces hardware and staffing costs at its venue, but can significantly improve its safety index rating and can become the market leader for conferences in the City.

It would be appreciated by those skilled in the art that various changes and modifications can be made to the illustrated embodiments without departing from the spirit of the present invention. All such modifications and changes are intended to be covered by the appended claims.

What is claimed is:

1. A method, comprising:
receiving a report of an incident, event, or action via blockchain from a first user;
verifying the accuracy of the report by an organization;
sending a fractionalized or full tokens from the organization to the first user via blockchain; and
storing a status and an accuracy of the report by the first user and the time to resolve the report by the organization in a public blockchain.

2. The method of claim 1, further comprising,
calculating a trust rating of the first user based on the verification of the accuracy of the report by the first user.

3. The method of claim 2,
wherein the value of the token(s) sent by the organization to the user is a function of at least one of the first user's trust rating, the report's value to the organization, and such user's actions performed per the organization's request.

4. The method of claim 1, wherein the report is one of a security threat, a safety issue, a maintenance issue, an area of congestion, traffic or a length of a line for a service, and a voluntary action performed by the user to share data to the organization per their request.

5. The method of claim 1, wherein the public blockchain is a distributed ledger that lives on all nodes in the system and stores all data for the reports or actions, verification of the accuracy of reports, and electronic token transactions related to sending, receiving, verifying and providing rewards for such user generated reports or actions.

6. The method of claim 1, further comprising,
calculating a safety index value for the organization based on a number of reports received by at least the first user and the length of time the organization took to resolve the reports.

7. The method of claim 1, further comprising,
offering goods or services by the organization; and
accepting the token(s) from the first user in exchange for a good or service.

8. A non-transitory computer-readable medium storing instructions, the instructions comprising:
one or more instructions that, when executed by one or more processors, at least partially implemented in hardware, of a device, cause the one or more processors to:
receive a report or action of an event via blockchain from a first user;
verify the accuracy of the report or action by an organization;
send a fractionalized or a full electronic token(s) from the organization to the first user via blockchain based on the report's verification; and
store the accuracy of the report by the first user and the time to resolve the report by the organization in a public blockchain.

9. The non-transitory computer-readable medium of claim 8, wherein one or more instructions that, cause the one or more processors further to:
calculate a trust rating of the first user based on the accuracy of the report by the first user, the report's value to organizations or such user's actions performed per an organization's request.

10. The non-transitory computer-readable medium of claim 9, wherein the value of the token(s) sent by the organization to the user is a function of the first user's trust rating.

11. The non-transitory computer-readable medium of claim 8, wherein the report is one of a security threat, a safety or maintenance issue, an area congestion, traffic or a length of a line for a service, and a voluntary action performed by the user to share valuable data to the organization per their request.

12. The non-transitory computer-readable medium of claim 8, wherein the public blockchain is a distributed ledger that lives on all nodes in the system and stores all data for the reports or actions, verification of the accuracy of reports, and electronic token transaction related to sending, receiving, verifying and providing rewards for such user generated reports or actions.

13. The non-transitory computer-readable medium of claim 8, wherein one or more instructions that, cause the one or more processors further to:
calculate a safety index value for the organization based on a number of reports received by at least the first user and the length of time the organization took to resolve the reports.

14. The non-transitory computer-readable medium of claim 8, wherein one or more instructions that, cause the one or more processors further to:
offer goods or services by the organization; and
accept the token(s) from the first user in exchange for a good or service.

15. A method, comprising
receiving a fractionalized or a full electronic token from an organization for a report at a location operated by the organization, the token being received by a first user account;
selecting an amount or value of electronic tokens to be transferred to a selected vendor in exchange for a good or service;
deducting the value of tokens from the first user account and transferring the value to the vendor.

16. The method of claim 15, further comprising,
selecting a vendor from a list of vendors that are geographically proximate to the location operated by the organization and/or the user's current location.

17. The method of claim 15, further comprising,
scanning a vendor QR code with a mobile device associated with the first user account; and
validate the vendor QR code;
wherein the vendor QR code is a physical code that represents the vendor's public wallet address.

18. The method of claim 15, further comprising,
generating a QR code by a mobile device associated with the first user account;
presenting the QR code to the vendor for electronic validation of the transaction.

19. The method of claim 15, further comprising,
deducting a transaction fee in addition to the value of tokens.

20. The method of claim 15, further comprising,
converting the value of the token to US dollars or other fiat currency as a calculation of the token value to the goods or services exchanged for such token.
